(19) United States
(12) Patent Application Publication
(10) Pub. No.: US 2017/0338659 A1
(43) Pub. Date: Nov. 23, 2017

(54) SYSTEMS AND METHODS FOR DISPATCHING MAXIMUM AVAILABLE CAPACITY FOR PHOTOVOLTAIC POWER PLANTS

(71) Applicants: Sinewatts, Inc., Charlotte, NC (US); THE UNIVERSITY OF NORTH CAROLINA AT CHARLOTTE, Charlotte, NC (US)

(72) Inventors: Shibashis BHOWMIK, Charlotte, NC (US); Robert W. COX, Charlotte, NC (US); Babak PARKHIDEH, Charlotte, NC (US)

(21) Appl. No.: 15/522,762

(22) PCT Filed: Oct. 28, 2015
(86) PCT No.: PCT/US15/57907

§ 371 Date: Apr. 27, 2017

Related U.S. Application Data
(60) Provisional application No. 62/069,822, filed on Oct. 28, 2014.

(51) Int. Cl. H02J 3/38; H02S 40/32; H02S 50/00; H02J 3/00

(52) U.S. Cl. CPC H02J 3/383; H02S 50/00; H02S 40/32; H02J 2003/007

(57) ABSTRACT

Systems, apparatuses, and methods for dispatching maximum available capacity for photovoltaic (PV) power plants are described. For an embodiment, a PV panel assembly comprises a first PV panel configured to generate direct current (DC) power and an inverter molecule coupled to the first PV panel. The inverter molecule is configured to convert the DC power generated by the first PV panel into alternating current (AC) power. Moreover, the inverter molecule includes a monitoring device configured to monitor a condition of the first PV panel. The monitored condition of the first PV panel is converted into electronic data for generating or creating a first adaptive PV panel model for the first PV panel. Information derived from the first adaptive PV panel model can be communicated to a third party, such as an electric utility company or an Independent System Operator (ISO).

### RELATED APPLICATION

This application claims, under 35 U.S.C. 119(e), the benefit of priority from U.S. Provisional Patent Application Ser. No. 62/069,822, filed on Oct. 28, 2014, the full disclosure of which is incorporated herein by reference.

### FIELD

Embodiments described herein relate generally to the field of photovoltaic power generation. More specifically, embodiments described herein relate to improving solar power output forecasting, remaining useful life (hereinafter “RUL”) prediction, and fault detection prediction for photovoltaic (hereinafter “PV”) power plants thereby allowing dispatchability of PV power plants by grid operators.

### BACKGROUND

Over the next 5-10 years the PV industry and utilities will be facing the next big challenge of rapid deployment and high penetration of PV in the energy generation mix. The rapid decline in PV power plant costs from $5.50/W in 2006 to $1.60/W in 2014 has created an unprecedented demand for PV generation in all segments of the market. Nevertheless, the potential high penetration of PVs along with the inherent variability or intermittency of the generation capacity of PVs is predicted to cause significant grid fluctuations, resource allocation issues and dynamic generation and load capacity matching challenges throughout the course of a day. This is because PV power is intermittently generated due to cloud cover, variability of sunlight, unpredictability of weather, etc. As a result, it is difficult to guarantee that a PV power plant will generate a specified amount of power, even if the PV power plant is designed to generate that specified amount. Consequently, the unpredictability associated with PV power generation makes it difficult to forecast a PV power plant's power generation capacity. In addition, the unpredictability associated with PV power generation makes it difficult for plant dispatchers (e.g., electrical utilities companies, independent system operators (ISOs), etc.) that are responsible for matching power generated by a PV power plant to an electrical grid to create reasonable plans that enable a balancing of load requirements by available generation capacity.

In order to mitigate the challenges associated with the dynamic variation of the PV power plant capacity, electric utilities and independent system operators (ISOs) require standby generation from other types of fast ramping power plants, such as, combined cycle power plants, natural gas-fired power plants, combustion turbine-based power plants, and other types of spinning reserves. Accordingly, a portion of the capacity of PV power plants must be maintained elsewhere, which requires substantial capital investments for deploying and operating resources.

Although presently-available solar resource forecasting tools can predict the output of a solar power plant, their capability is slightly limited because they must assume: (i) a fixed plant condition; (ii) prediction of generation capacity based on historical performance; and (iii) some form of rudimentary and static time-dependent degradation model. These assumptions are required because the cost of monitoring individual PV panels with state of the art solutions can be prohibitively expensive.

### SUMMARY

Embodiments described herein relate to systems, apparatuses, and methods for dispatching maximum available capacity for photovoltaic (PV) power plants. For an embodiment, a photovoltaic (PV) panel assembly comprises a first PV panel configured to generate direct current (DC) power and an inverter molecule coupled to the first PV panel. The inverter molecule is configured to convert the DC power generated by the first PV panel into alternating current (AC) power. For a further embodiment, the inverter molecule includes a monitoring device configured to monitor a condition of the first PV panel. The monitored condition of the first PV panel can be converted into electronic data that is used to create a first adaptive PV panel model for the first PV panel. The monitored condition of the first PV panel can include at least one of the following: (i) a yield of the first PV panel, where the yield of the first PV panel is a measure of energy derived from the power generated by the first PV panel; (ii) a temperature characteristic of the first PV panel; (iii) a voltage characteristic of the first PV panel; or (iv) a current characteristic of the first PV panel. The monitoring of the first PV panel can be performed in real-time. In addition, at least one of a key performance indicator (KPI) of the first PV panel or a degradation profile of the first PV panel is generated over a durational window based on the first adaptive PV panel model. The KPI of the first PV panel is indicative of at least one of a future yield of the first PV panel, a future short circuit current of the first PV panel, a future open circuit voltage of the first PV panel, a predicted maximum power of the first PV panel, a predicted voltage at a predicted maximum power of the first PV panel, and a predicted current at a predicted maximum power of the first PV panel, and the degradation profile of the first PV panel being indicative of a quantification of a decline in an ability of the first PV panel to generate DC power over time. The degradation profile of the first PV panel is indicative of a quantification of a decline in an ability of the first PV panel to generate DC power over time. The durational window can include at least one of a minutes-ahead window, a hours-ahead window, a days-ahead window, or any other window specifying a predetermined duration. For one embodiment, the first adaptive PV panel model can be combined with a second adaptive PV panel model associated with a second PV panel to generate a third adaptive PV panel model for both the first and second PV panels. In this way, multiple PV panel models associated with multiple PV panels of a PV power plant can be aggregated to generate a single adaptive PV panel model that provides useful information about the entire PV plant's power generation capabilities. The information derived from an adaptive PV panel model (e.g., the KPI and/or the degradation profile associated with an entire PV power plant) can be communicated to a third party, such as an electric utility company or an Independent System Operator (ISO), that controls dispatching of the PV power plant's generation resources.

Other advantages and features will become apparent from the accompanying drawings and the following detailed description.

### BRIEF DESCRIPTION OF THE DRAWINGS

Embodiments described herein are illustrated by way of example and not limitation in the figures of the accompanying drawings, in which like references indicate similar elements.

FIG. 1 is a block diagram of one embodiment of a system for dispatching of maximum available capacity for photovoltaic (PV) power plants.

FIG. 2 is a pictorial illustration of a PV panel assembly in accordance with an embodiment. The PV panel assembly of FIG. 2 can be included in the system of FIG. 1.

FIG. 3A is a pictorial illustration of an inverter molecule in accordance with an embodiment.

FIG. 3B is a block diagram illustration of an inverter molecule according to an embodiment. The inverter molecule of FIG. 3B provides additional details about the inverter molecule of FIG. 3A.

FIG. 4 is a schematic illustration of a PV panel assembly in accordance with an embodiment.

FIG. 5 is a schematic illustration of PV panel assembly in accordance with another embodiment.

FIG. 6 is a flow chart illustration of a process of fault detection, fault diagnosis, and/or yield prediction in accordance with one embodiment.

FIG. 7 is a block diagram illustration of a cloud-based system according to an embodiment.

FIG. 8 is a block diagram illustrating an example of a data processing system 800 that may be used with at least one of the embodiments described herein.

### DETAILED DESCRIPTION

Embodiments described herein set forth systems, apparatuses, and methods for dispatching maximum available capacity for photovoltaic (PV) power plants. For an embodiment, a photovoltaic (PV) panel assembly comprises a first PV panel configured to generate direct current (DC) power and an inverter molecule coupled to the first PV panel. The inverter molecule is configured to convert the DC power generated by the first PV panel into alternating current (AC) power. For a further embodiment, the inverter molecule includes a monitoring device configured to monitor a condition of the first PV panel. The monitored condition of the first PV panel is converted into electronic data that is used to create a first adaptive PV panel model for the first PV panel. Information derived from the first adaptive PV panel model can be communicated to a third party, such as an electric utility company or an Independent System Operator (ISO), that controls dispatching of the PV power plant's generation resources.

Some presently available solar resource forecasting tools are limited. Thus, the predicted accuracy for PV plant output(s) can be improved when a PV power-plant model reflects the real-time condition of each individual PV panel of the plant. For example, vegetation growth causing shading to develop over a section of a PV power plant's panels would prevent the power plant from outputting as much energy as specified by its rated capacity even though the PV power plant's power electronics can adapt and ensure that each individual PV panel is operated at maximum output power. In this example, connecting diagnostic and monitoring electronics at the panel level while requiring a radio, transmitter, or transceiver for basic operation can assist with enabling improved tracking of each individual PV panel's output. Thus, advanced PV power plant models coupled with adaptive predictive tools can provide a high level of predictive accuracy as required by electric utilities and independent system operators (ISOs) in the marketplace. One of the non-limiting advantages of the embodiments described herein is directed to providing a high level of predictive accuracy required by electric utilities and ISOs in the marketplace. This increased predictive accuracy can assist with reducing or eliminating the use of capital-intensive spinning reserves as backups for PV power plants.

Improvements in weather forecasting and computing power have made it possible to provide improved forecasts of PV power plant output. These forecasts can be measured in durational windows, such as minutes-ahead, hours-ahead, and days-ahead windows. Given that each individual PV panel changes its performance over time, accurate predictions of yield and power are possible when these improved forecasts incorporate an adaptive model for each individual panel. These adaptive models can also be used to detect faults and to predict the RUL of each individual PV panel.

For one or more of the embodiments described herein, data (such as actual yield, current characteristics, voltage characteristics, etc.) are assumed to be available from individual PV panels. The data from an individual PV panel is referred to herein as “PV panel data” and is measured over a predetermined duration, e.g., on a daily basis.

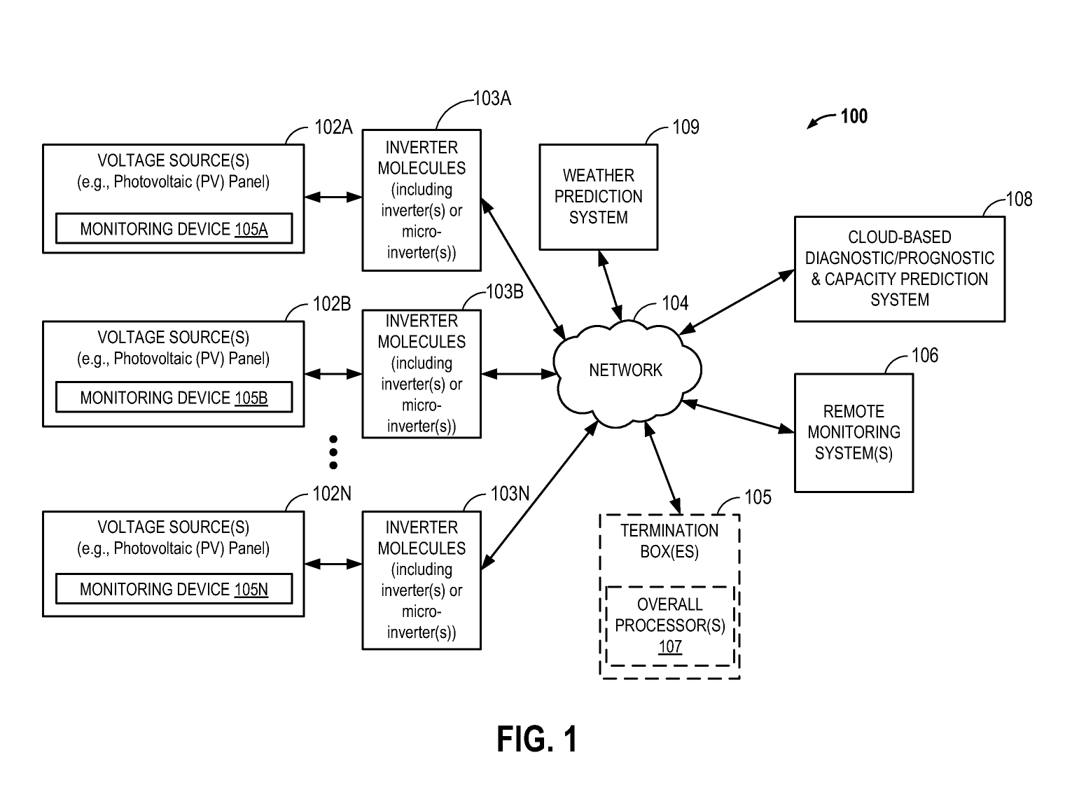

FIG. 1 is a block diagram of one embodiment of a system 100 for dispatching of maximum available capacity for photovoltaic (PV) power plants according to one embodiment. System 100 of FIG. 1 includes voltage sources 102A-N. Each one of voltage sources 102A-N can be any device capable of generating direct current (DC) power, such as a battery consisting of two or more electrochemical cells that convert stored chemical energy into electrical energy or a PV panel comprised of one or more PV cells. For the sake of brevity, a voltage source will be referred to herein simply as a “PV Panel.” As used herein, a “PV cell,” a “solar cell,” and their variations refer to an electrical device that converts the energy of light into electricity by a photovoltaic effect, which is a physical and chemical phenomenon. A PV cell is a form of a photoelectric cell, which is defined as a device whose electrical characteristics, such as current, voltage, or resistance, vary when exposed to light. PV cells are the building blocks of PV panels.

System 100 also includes multiple inverter molecules 103A-N, where each molecule 103A-N includes one or more inverters or micro-inverters. Each one of PV panels 102A-N is coupled to a respective one of inverter molecules 103A-N. A combination of a PV panel (e.g., panel 102A) and an inverter molecule (e.g., inverter molecule 103A) that are coupled to each other forms a PV panel assembly. A PV panel assembly is used for acquiring or generating direct current (DC) energy from a solar source and converting such energy into alternating current (AC) energy for many uses as is known in the art (e.g., electricity generation, etc.). It is to be appreciated that a PV panel assembly can include more than one PV panel (e.g., PV panel 102A and 102B) being coupled to a single inverter molecule (e.g., inverter molecule 103A). Moreover, a plurality of PV panel assemblies can be connected to each other in a string configuration or an array configuration. For example, and for one embodiment, a plurality of PV panel assemblies formed from PV panels 102A-N and inverter molecules 103A-N are connected in a series connection to form a string. A PV power plant is comprised of a plurality of PV panel assemblies that are connected to each in at least one of a string configuration or an array configuration.

System 100 also includes a weather prediction system 109, a cloud-based system 108, a remote monitoring system 106, and one or more optional termination boxes 105 that communicate with each other via network 104. Each of these elements of system 100 are described below.

Network 104 can be at least one of a wired or wireless network. Network 104 can include at least one of an Ethernet-based network, a Wi-Fi-based network, a Bluetooth-based network, Zigbee-based network, Cellular Network, Radio Frequency Signal network, or any other type of suitable network that enables communication of data between the PV panels 102A-N, the inverter molecules 103A-N, the weather prediction system 109, the cloud-based system 108, the remote monitoring system 106, and the termination box(es) 105. For one embodiment, each of the PV panels 102A-N, the inverter molecules 103A-N, the weather prediction system 109, the cloud-based system 108, the remote monitoring system 106, and the termination box(es) 105 includes circuitry required for communication via network 104. For example, and for one embodiment, each of elements of system 100 includes at least one of a radio, a transmitter, or a transceiver for communicating data among each other via network 104. Each element of system 100 can also include a network interface (not shown), such as an Ethernet interface, universal bus interface, or Wi-Fi interface (such as IEEE 802.11, 802.11a, 802.11b, 802.16a, Bluetooth, Proxim's OpenAir, HomeRF, HiperLAN and others) that enables communication with the other elements of system 100 when network 104 is a wireless network.

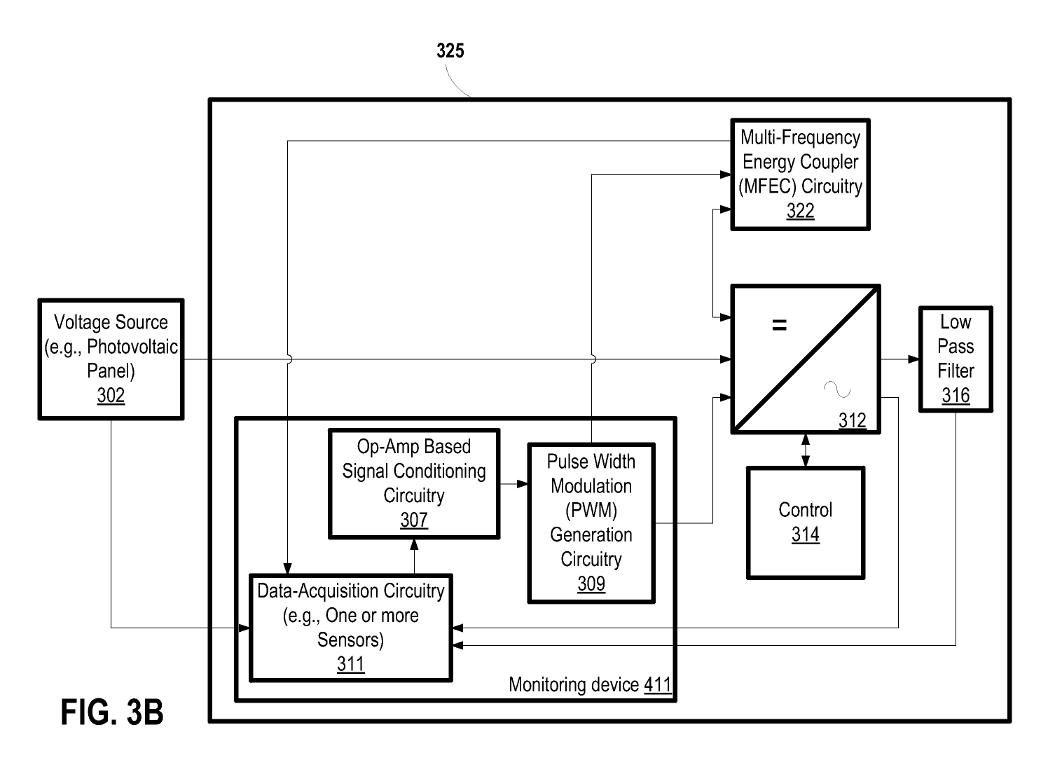

For one embodiment, system 100 of FIG. 1 is configured to acquire PV panel data by measuring or monitoring PV panel data from one or more PV panels 102A-N. System 100 can use the acquired PV panel data to create an adaptive PV panel model for one or more individual PV panels 102A-N. For one embodiment, the cloud-based system 108 generates an adaptive PV for each PV panel 102A-N based on the acquired PV panel data. For a further embodiment, the cloud-based system 108 aggregates the acquired PV panel of multiple PV panels 102A-N and uses the aggregated data to generate a single adaptive PV for the multiple PV panels 102A-N. For one embodiment, the cloud-based system 108 generates a degradation profile for each PV panel 102A-N based on the acquired PV panel data. For a further embodiment, the cloud-based system 108 aggregates the acquired PV panel of multiple PV panels 102A-N and uses the aggregated data to generate a single degradation profile for the multiple PV panels 102A-N. Additional details about the adaptive PV panel model and the degradation profile are provided below in connection with at least FIG. 3B, 4, 5, or 6.

For one embodiment, each of inverter molecules 103A-N includes one or more monitoring devices 105A-N for measuring or monitoring PV panel data acquired from a respective one of PV panels 102A-N. For one embodiment, each of the monitoring devices 105A-N performs a current-voltage sweep (IV sweep) for a respective one of the PV panels 102A-N. As used herein, an “IV sweep” and its variations refer to a relationship between a current characteristic and a voltage characteristic of a PV panel, which is known an IV characteristic. A PV panel's IV characteristic is one that shows, for example, maximum power current and maximum power voltage that generate maximum power, and it is an important characteristic for evaluating performance of the PV panel. An IV characteristic can be measured by rapidly sweeping applied voltage to the PV panel between short-circuit current and open-circuit voltage while the PV panel is irradiated with sunlight, and measuring current and voltage outputted from the PV panel at the time.

The monitoring devices 105A-N can include one or more processors that are used to perform the acquisition of data from the respective PV panels 102A-N. Each processor of the monitoring devices 105A-N includes circuitry for this monitoring or measuring the data from the PV panels 102A-N. For one embodiment, each processor of the monitoring devices 105A-N enables the monitoring or measuring of the data from each of the PV panels 102A-N to be performed in real-time or on-demand as may be needed. For this embodiment, each processor of the monitoring devices 105A-N controls the monitoring or measuring of the data from each of the PV panels 102A-N. Circuitry of each processor of the monitoring devices 105A-N can include a number of execution units, logic circuits, and/or software used for measuring or monitoring the data from the PV panels 102A-N. For example, and for one embodiment, circuitry of a processor of a monitoring device 105A that implements one or more functionalities described herein can be embodied in programmable or erasable/programmable devices, a field-programmable gate array (FPGA), a gate array or full-custom application-specific integrated circuit (ASIC), or the like. The functionalities of the processor can be performed using, for example, micro-code of a complex instruction set computer (CISC), firmware programmed into programmable or erasable/programmable devices, the configuration of an FPGA, the design of a gate array or full-custom ASIC, or the like. Additional details about the monitoring devices 105A-N is provided below in connection with at least FIGS. 3A-5.

For one embodiment, the monitoring devices 105A-N are built into the inverter molecules 103A-N during the production of the inverter molecules 103A-N. One advantage of this embodiment is that there is no need to install or maintain monitoring systems that are external to a PV panel assembly. Thus, this embodiment can assist with reducing or eliminating some or all of the costs associated with presently-available external monitoring systems. PV panel data can include at least one of the voltage characteristics of the PV panels 102A-N, the current characteristics of the PV panels 102A-N, the actual yields (i.e., the actual energy derived from power generated) of the PV panels 102A-N, or the temperature characteristics of the PV panels 102A-N.

Monitored or measured PV panel data acquired by the monitoring devices 105A-N can be communicated, via network 104, to the cloud-based system 108 of system 100. As used herein, a “cloud-based system” and its variations refers to at least one computer or at least one data processing system comprising a user environment in which programs or materials are stored in one or more computers that can be accessed through a telecommunications network (e.g., a computer network, a data network, a local area network (LAN), a wide area network (WAN), the Internet, etc.) so that desired operations can be performed remotely using various terminals such as smartphones, laptop computers, desktop computers, and other computing systems as is known in the art. For other embodiments, the cloud-based system 108 may be part of a PV power plant and may communicate with one or more optional termination boxes 105 (as described below) utilizing the telecommunications network 104 (as described above). For these embodiments, the PV power plant is comprised of one or more PV panel assemblies, where each PV panel assembly includes one or more PV panels 102A-N and one or more inverter molecules 103A-N.

For one embodiment, at least one of inverter molecules 103A-N communicates the acquired data to at least one optional termination box 105, which then communicates the acquired data to the cloud-based system 108. In one embodiment, the one or more optional termination boxes 105 include at least one overall processor 107 for coordinating the overall monitoring or measuring of the data from each of the PV panels 102A-N. For one embodiment, the overall processor 107 enables the monitoring or measuring of the data from each of the PV panels 102A-N to be performed in real-time or on-demand as may be needed. For this embodiment, the processor 107 communicates with the inverter molecules 103A-N to coordinate the monitoring or measuring of the data from each of the PV panels 102A-N. Circuitry of the processor(s) 107 of the termination box 105 can be similar to or the same as the processor(s) of the monitoring devices 105A-N, which are described above. For another embodiment, the one or more terminal boxes 104 are optional. For this embodiment, the inverter molecule(s) 103A-N communicate the acquired data directly to the cloud-based system 108 via network 104. Thus, in at least one embodiment of system 100, the termination box 105 is not necessary.

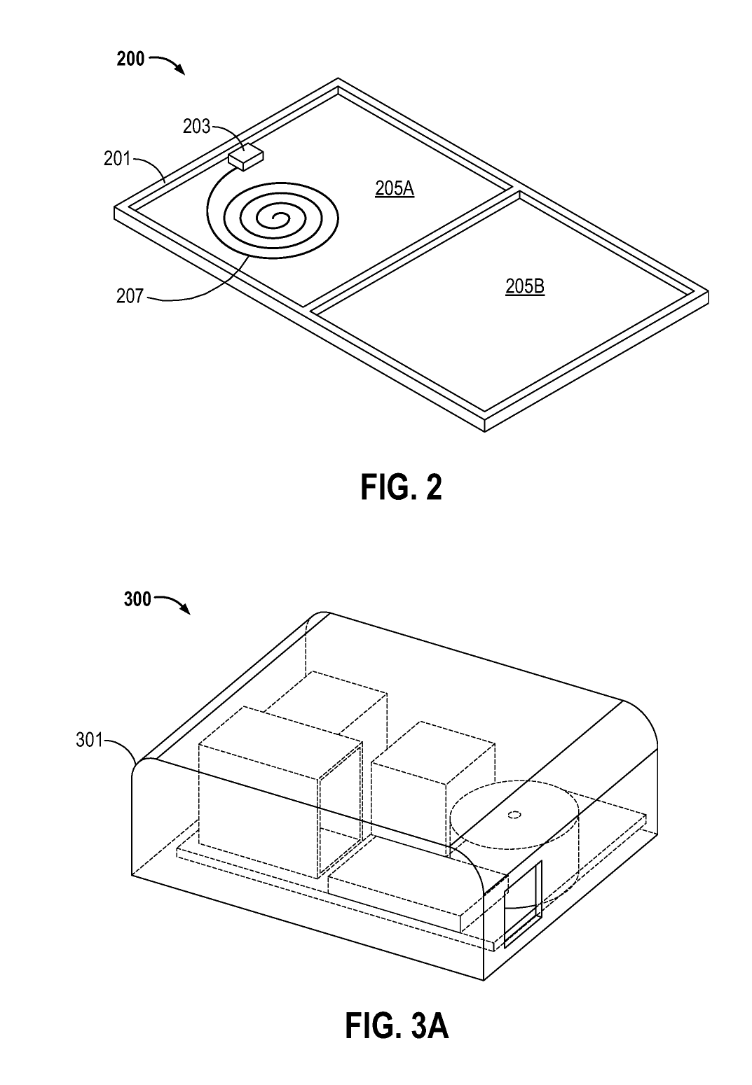

For one embodiment, the cloud-based system 108 processes the received PV panel data to generate an adaptive PV panel model for a respective one of PV panels 102A-N. Additional details adaptive PV panel model are discussed below in connection with at least one of FIGS. 2-7. After the PV panel data has been processed, the cloud-based system 108 can update an adaptive PV panel model of each individual PV model. For example, the adaptive PV panel model is updated using at least one of a parameter-identification algorithm or a learning algorithm, as is known in the art. For a further example, algorithms based on non-linear regression analysis, algorithms based on other forms of regression analysis known in the art, or algorithms based on Bayesian techniques can be performed on an existing adaptive PV panel model to update the model.

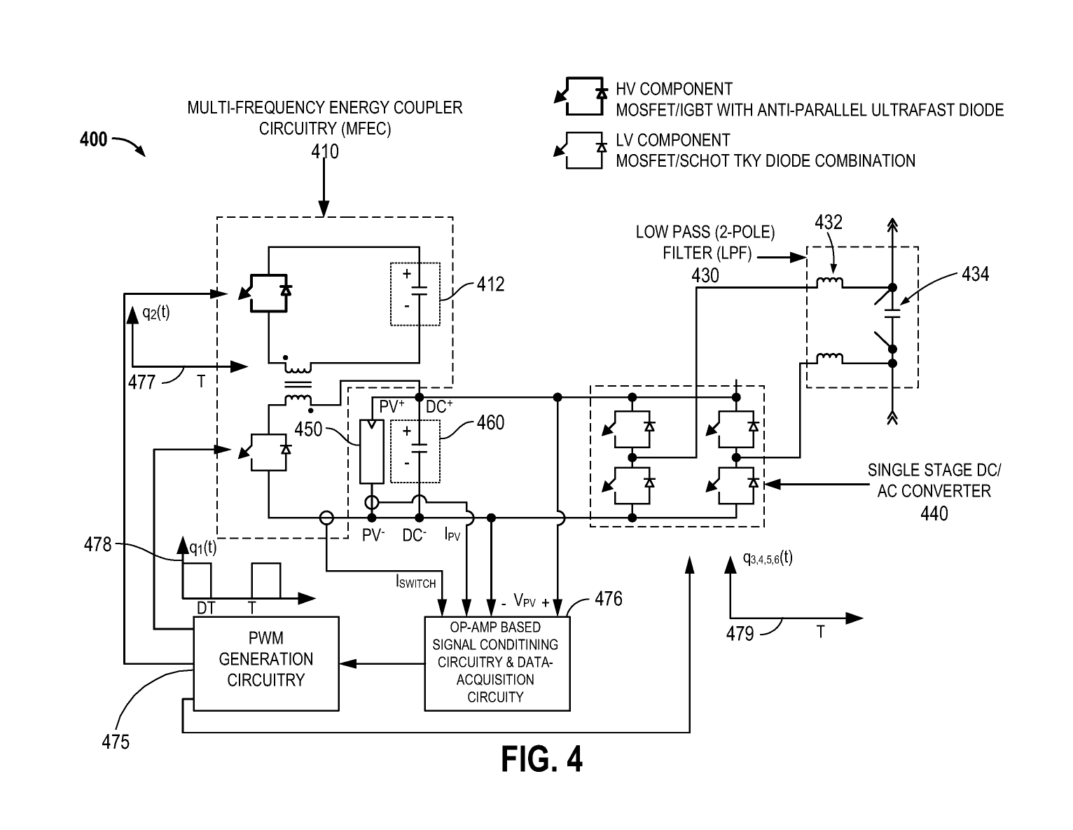

For an embodiment, a weather prediction system 109 communicates weather data to the cloud-based system 108. For this embodiment, the cloud-based system 108 combines the weather data with the adaptive PV panel models to compute predictions of the performance capabilities or characteristics of a respective one of PV panels 102A-N. For example, the weather data and the adaptive PV panel model for PV panel 102A is used to compute a future yield (i.e., a future energy derived from power to be generated by the PV panel 102A for a specified durational window). In this example, the future yield is a key performance indicator (KPI) for the PV panel 102A. KPIs are described below in connection with FIG. 4. As used herein, a “weather prediction system,” a “weather system,” and their variations refer to at least one computer or at least one data processing system that includes weather data indicative of weather from different sources for different sets of weather data locations. The weather prediction system 109 can include one or more processors that estimate or derive weather observations/conditions for any given location using observed weather conditions from neighboring locations, radar data, lightning data, satellite imagery and other techniques known in the art. For an embodiment, the durational window can be at least one of a minutes-ahead window, an hours-ahead window, a days-ahead window, or any other window specifying a predetermined duration.

System 100 also provides a non-limiting example of a cloud-based system 108 that combines weather data received from the weather prediction system 109 with PV panel data for computing predictions. For a further embodiment, the cloud-based system 108 aggregates the acquired PV panel data from all of the individual panels 102A-N of a PV power plant, and generates a set of predictions for the PV power plant. For yet another embodiment, the generated set of predictions for the PV power plant is based on the weather data acquired from the weather prediction system 109. The cloud-based system 108 can communicate the set of predictions to appropriate authorities (e.g., electric utilities, ISOs, etc.) as needed to control the dispatch of the PV power plant on the grid.

For an embodiment, the acquired PV panel data can also be used to perform at least one of fault detection, diagnosis, or prognosis. Here, algorithms having appropriate aging models predict when an individual panel will reach a specific level of performance degradation. Algorithms for predicting degradation rates of PV panels are well known, and as a result, these algorithms are not discussed in detail. Algorithms for predicting a degradation rate of a PV panel can include, but are not limited to, algorithms based on regression analysis and algorithms based on Bayesian techniques.

For a further embodiment, PV panel models for each individual panel are aggregated to predict when the entire PV power plant will reach a specific performance degradation. System 100, therefore, also provides a non-limiting example of using PV panel data to determine a time until an individual panel or an entire plant reaches a minimum performance threshold. Additionally, the granular information and degradation predictions can provide ancillary services such as improved voltage regulation.

System 100 also includes a remote monitoring system 106. As used herein, a “remote monitoring system” and its variations refer to at least one computer or at least one data processing system that communicates with at least one of the cloud-based system 108, the inverter molecule(s) 103A-N, or the termination box 105 (if available) to analyze the PV panel models for at least one of monitoring the generated predictions, monitoring the PV panel models, and detecting or diagnosing issues of one or more of the PV panels 102 A-N. The remote monitoring computer or system 106 communicates via network 104. For one embodiment, the remote monitoring computer or system 106 is associated with a third party—for example, an electric utilities company, an ISO, etc.—that uses the predictions and the PV panel models as needed to control or adjust dispatching of a PV power plant's generation resources. For yet another embodiment, the knowledge of the PV plant capacity may allow the third party to dispatch other generating resources to balance the requirements of the load on the grid. For example, and for one embodiment, a plant dispatcher (e.g., an electrical utilities company or an ISO) can use the knowledge of the PV plant capacity (i.e., the predictions and the PV panel models) of an entire PV power plant that is produced by the system 100 to assist with reducing or eliminating the use of capital-intensive spinning reserves as backups for the PV power plant.

FIG. 2 is a pictorial illustration of PV panel assembly 200 in accordance with an embodiment. The PV panel assembly 200 can be included in system 100, which is described above in connection FIG. 1. As explained above, a PV panel assembly (e.g., the PV panel assembly 200) is formed from a combination of at least one PV panel (e.g., the panel 205A-B) and at least one inverter molecule (e.g., the inverter molecule 203) that are coupled to each other. In the illustrated embodiment shown in FIG. 2, the PV panel assembly 200 includes a frame 201, an inverter molecule 203, two PV panels 205A-B, and an optional connector 207 for coupling or connecting the PV panel assembly 200 to a termination box (not shown), an electrical grid (not shown), another PV panel assembly (not shown), or an electrical load as is known in the art. The connector 207 can be a wired connector as is known in the art. The inverter molecule 203 is similar to or the same as the inverter molecules 103A-N described above in connection with FIG. 1. Furthermore, the PV panels 205A-B are similar to or the same the PV panels 102A-N described above in connection with FIG. 1. The frame 201 is used for housing the other elements of the PV panel assembly 200. In one embodiment, the frame 201 is made from metal, plastic, or any suitable materials known in the art.

It is to be appreciated that PV panel assembly 200 can include more than two PV panels 205A-B or less than two PV panels 205A-B. Thus, the PV panel assembly can include at least one PV panel.

FIG. 3A is a pictorial illustration of an inverter molecule 300 in accordance with an embodiment. The inverter molecule 300 can be included in the system 100 described above in connection with FIG. 1 or the PV panel assembly 200 described above in connection with FIG. 2. The inverter molecule 300 is similar to or the same as the inverter molecules 103A-N or 203 described above in connection with FIGS. 1 and 2. The inverter molecule 300 includes several components that are encased in a housing 301. The components encased in the housing 301 are described below in connection with FIG. 3B.

For one embodiment, the inverter molecule 300 has an approximate height between 2 inches and 2.5 inches, an approximate width between 2 inches and 2.5 inches, and an approximate length between by 3 inches and 3.5 inches. Additional details about the inverter molecule 300 as described herein is provided below in connection with FIG. 3B.

FIG. 3B is a block diagram illustration of an inverter molecule 325 in accordance with an embodiment. The inverter molecule 325 of FIG. 3B provides additional details about the inverter molecule 300 of FIG. 3A.

Referring now to FIG. 3B, an inverter molecule 325 can include a DC-to-AC inverter 312, a control block 314, a low-pass filter (LPF) 316, a multi-frequency energy coupler (MFEC) 322, and a monitoring device 305. A voltage source 302 (e.g., a PV panel 302) can also be coupled to the DC-to-AC inverter 312 in the inverter molecule 325. For some embodiments, these recited components of the inverter molecule 325 can be provided in, for example, any of the inverter molecules as described above with respect to FIGS. 1-3A. For other embodiments, multiple PV panels 302 can be coupled to the inverter molecule 325. The DC-to-AC inverter 312 can also include a boost/buck circuit and/or a DC-to-AC H-bridge inverter (not shown in FIG. 3B). As a result of exposure from sunlight, for example, a PV panel 302 can provide a DC output to the inverter molecule 325. The combination of PV panel 302 and inverter molecule 325 can form a PV panel assembly, as described above in connection with at least FIG. 2. For one embodiment, the PV panel assembly of FIG. 3B is a solar PV energy collection and conversion system that includes at least one PV panel 302 and at least one inverter molecule 325.

For one embodiment, the DC-to-AC inverter 312 can be in communication with a controls/communications block 314. One or more electrical signals can pass between the DC-to-AC inverter 312 and the controls/communications block 314. The electrical signals can include command information that can be exchanged for controlling the DC-to-AC inverter 312 (and in turn, the inverter molecule 325). For example, the commands can control one or more parameters relating to converting a DC voltage to an AC voltage. Such parameters can include the voltage that the DC-to-AC inverter 312 can operate at, and/or the current amounts that the DC-to-AC inverter 312 can operate at. For some embodiments, monitoring information can be passed from the DC-to-AC inverter 312 to the controls/communications block 314. Such monitoring information may provide feedback to the controls/communications block 314 in order to better maintain or alter the commands provided to the DC-to-AC inverter 312. Thus, in each inverter molecule 325, depending on different implementations, a one-way communication can be provided from the controls/communications block 314 to the DC-to-AC inverter 312, a one-way communication can be provided from the DC-to-AC inverter 312 to the controls/communications block 314, or two-way communications can be provided between the controls/communications block 314 and the DC-to-AC inverter 312.

The controls/communications block 314 can also communicate with other control blocks 314 of other inverter molecules 325 (not shown). According to some embodiments, the controls/communications block 314 can receive instructions from an overall processor—for example, a processor 107 of the termination box 104 described above in connection with FIG. 1. For these embodiments, the controls/communications block 314 can permit synchronized current generation among a plurality of inverter molecules 325. For some other embodiments, the controls/communications block 314 can be dynamically delegated as being a master controls/communications block 314 of a plurality of inverter molecules 325 while the other controls/communications blocks 314 of the other inverter molecules 325 within a string are configured to be slave controls/communications blocks. Each controls/communications block 314 can also be capable of adjusting the power output of its respective inverter molecule 325 at its maximum power point or an improved power point.

The DC-to-AC inverter 312 can also communicate with a multi-frequency energy coupler (MFEC) 322. For example, in order to meet the requirements of the double frequency (120 Hz) power on an electrical grid when the PV panel 302 is generating DC power, the MFEC 322 acts as an energy storage that provides power balancing between the DC power (from the PV panel 302) and single-phase AC power (to be outputted by the inverter molecule 325). For one embodiment, the MFEC 322 allows for a low cost means for energy storage necessary for DC to double the frequency power balancing. In one scenario, the PV panel assembly of FIG. 3 can be based on low voltage circuits and components, and if a presently available energy storage device used for power balancing is placed on the low voltage bus, then a capacitor with a high capacitance is required. Such a capacitor can be prohibitively expensive. The MFEC 322 can be used to avoid use of such an expensive capacitor because the MFEC 322 has a higher voltage than presently available energy storage devices that are used for power balancing. Specifically, because energy stored in a capacitor is proportional to the square of the voltage of the capacitor, increasing the voltage of the energy storage (i.e., the MFEC 322) can reduce the capacitance of energy storage device's passive element (i.e., the capacitor). In order to reduce the required capacitance, the MFEC 322 includes a higher voltage bus that allows for a capacitor of a lower capacitance.

For one embodiment, an electrical grid (not shown) can demand AC power that is lower than the DC power obtained from a PV panel 302 and converted to AC power by the inverter molecule 325. In such situations, energy can be stored by using the MFEC 322. Alternatively, in cases where the grid demand is higher than the power obtained from the PV panel 302 and converted by the inverter molecule 325, energy can be used from the MFEC 322. Thus, for at least one embodiment, the MFEC 322 can handle and/or accommodate the DC energy supplied by the PV panel 302 and converted by the inverter molecule 325 for delivery to an electrical grid. Because the MFEC 322 can permit increased voltage, which can result in reduced capacitance, high-reliability film capacitors can be used for the energy storage. This can provide advantages over electrolytic energy storage configurations. For alternate embodiments, electrolytic energy storage can also be used in combination with or in place of the high-reliability capacitors of the MFEC 322. These alternate embodiments can enable the MFEC 322 to provide increased grid stability functionalities such as, reactive power compensation, power factor correction, voltage sag ride through and/or other similar grid disturbance prevention that are being gradually mandated by electrical utilities companies or ISOs.

For some embodiments, command/communication signals can also be exchanged between the MFEC 322 and the DC-to-AC inverter 312. These communications can be a two-way communication, or one-way communication/commands from the DC-to-AC inverter 312 to the MFEC 322, or vice versa. For other embodiments, the MFEC 322 can directly receive control signals from the controls/communications block 314. Using the command signals, the MFEC 322 can be configured to handle 120 Hz power that is demanded by a grid current while maintaining DC power delivery operation of the PV panel 302 and generating 60 Hz current for the 60 Hz voltage on an electrical grid. In one embodiment, the MFEC 322 can be capable of handling any frequency power demanded by a grid current while generating another frequency or the same frequency current for the voltage on an electrical grid. In some instances, the output frequency power to an electrical grid may be the same as, double, triple, or any multiple of the frequency current for the voltage on the electrical grid. The MFEC 522 can also adjust the power output of the inverter molecule 325 at its maximum power point or an improved power point.

According to one or more embodiments, the inverter molecule 325 can include a low-pass filter (LPF) 316. The LPF 316 can pass low-frequency signals while attenuating signals with a frequency higher than a cut-off frequency. The amount of attenuation can depend on the application and/or the particular signal. The LPF 316 can also be in communication with at least one of the DC-to-AC inverter 312 or another inverter molecule 325. For one embodiment, the LPF 316 communicates with at least one of an overall processor or another LPF 316 of another inverter molecule 325. In some instances, an LPF 316 can be delegated to be a master LPF 316 (e.g., dynamically), while other LPFs 316 of other inverter molecules 325 are configured to be slave LPFs 316. In one embodiment, the LPF 316 can include passive components (e.g., small passive components) that can reduce cost, weight, volume, and/or increase the power density of the LPF 316.

For some embodiments, the LPF 316 can provide a current to be outputted from the inverter molecule 325 and can provide an alternating current from which high frequencies have been attenuated or removed (e.g., the LPF 316 can process or modify the current that is outputted from the DC-to-AC inverter 312). Currents outputted from the inverter molecule 325 can be provided to a load center or an electrical grid. In some instances, the outputted current can pass through the LPFs 316 and/or other types of filters before reaching the load center or the electrical grid.

For some embodiments, the one or more components of the inverter molecule 325 can include both high-voltage (HV) and low-voltage (LV) components. The HV component can comprise a metal-oxide-semiconductor field effect transistor (MOSFET) and/or insulated gate bipolar transistor (IGBT) with an anti-parallel ultrafast diode, while the LV component can comprise a MOSFET and/or Schottky diode combination. Depending on implementations, there can be advantages for using MOSFETS. For example, MOSFETs may permit the reverse flow of current, can be more efficient than IGBTs, and/or can permit faster switching than IGBTs. The use of MOSFETs can be permitted by the low voltages used in the inverter molecule 325. Additionally, to further improve the efficiency of conversion, gate drive energy recovery circuits can be employed for the power switches. This gating energy is typically dissipated in conventional IGBT-based centralized inverters and micro-inverters due to the difficulty (because larger passive components are required) in designing such circuits around slower switching speed semiconductor switches. MOSFET-based implementation of the inverter molecule 325 can also benefit from the utilization of two different types of MOSFETs—one that is optimized for higher switching speeds, and the other that is optimized for low conduction drop. For example, the former type of MOSFET can allow the implementation of the high switching frequency pulse width modulation, while the latter type of MOSFET can allow grid frequency commutation provided at a low conduction drop for the reversal in direction of the grid AC currents.

For one embodiment, using two different types of MOSFETS (one that is optimized for high switching speeds and another that is optimized for low switching speeds) in one or more of the components of the inverter molecule 325 allows for lower commutation losses and the synthesis of purely sinusoidal AC waveforms allows AC voltage summation with minimal bandwidth controller communications and no central processing for voltage generation, current control and load/grid interface. This can enable inverter molecule 325 to provide a low cost implementation for substantially higher volumetric and gravimetric densities with implementable communication techniques and bandwidth limitations association with them. For one embodiment, the inverter molecule 325 can achieve switching frequencies that are at least 500 kHz, which can allow for increased power densities. For one embodiment, one or more components of the inverter molecule 325 include at least one of the following: (i) an inductor with an inductance of at least 0.25 Henry (H) required for low switching frequencies; and (ii) an inductor with an inductance with a range of 5 μH to 10 μH. For another embodiment, one or more components of the inverter molecule 325 includes an inductor with an inductance with a range of 5 μH to 10 μH. The use of an inductor with a range of 5 μH to 10 μH enables miniaturization of the circuitry of the inverter molecule 325 and enables the inverter molecule 325 to operate without peer-level or peer-to-central communications. For a further embodiment, the information that is broadcasted to the control block 314 of the inverter molecule 325 is a low bandwidth grid voltage zero-cross timing.

For one embodiment, the inverter molecule 325 includes a monitoring device 305. The monitoring device 305 provides additional details about the monitoring devices 105A-N described above in connection with FIG. 1. For one embodiment, the monitoring device 305 includes at least one of the following: (i) data-acquisition circuitry 311; (ii) operational amplifier (Op-Amp) based signal conditioning circuitry 307; or (iii) pulse width modulation (PWM) generation circuitry 309. For one embodiment, each of the data-acquisition circuitry 311, the Op-Amp based signal conditioning circuitry 307, and the PWM generation circuitry 309 is implemented by a processor of the monitoring devices 305 (not shown). For a further embodiment, the processor implementing circuits 311, 307, and 309 enables the monitoring or measuring of the data from the PV panel 302 to be performed in real-time or on-demand as may be needed.

As used herein, a “data-acquisition circuit” or its variations refer to one or more circuits configured to detect or measure PV panel data. PV panel includes, but is not limited to, at least one of a voltage characteristic of a PV panel, a current characteristic of a PV panel, a yield of a PV panel (i.e., an amount of energy derived from power generated by a PV panel), or the temperature characteristic of a PV panel. For one embodiment, the data-acquisition circuit 311 includes at least one sensor that obtains the PV panel data from at least one of the PV panel 302 or the inverter molecule 325. As used herein, a “sensor” or its variations refer to an object, device, or system used for detecting events or changes in a specific operating environment, and then provide a corresponding output. For example, and for one embodiment, at least one sensor is used to monitor an operating environment of at least one of PV panels 102A-N. Examples of a sensor include, but are not limited to, a pyranometer, a voltage sensor, a current sensor, a resistance sensor, a thermistor sensor, an electrostatic sensor, a frequency sensor, a temperature sensor, a heat sensor, a thermostat, a thermometer, a light sensor, a differential light sensor, an opacity sensor, a scattering light sensor, a diffractional sensor, a refraction sensor, a reflection sensor, a polarization sensor, a phase sensor, a florescence sensor, a phosphorescence sensor, an optical activity sensor, an optical sensor array, an imaging sensor, a micro mirror array, a pixel array, a micro pixel array, a rotation sensor, a velocity sensor, an accelerometer, an inclinometer, and a momentum sensor.

As used herein, an “Op-Amp based signal conditioning circuit” or its variations refer to one or more circuits that process the PV panel data acquired by the data-acquisition circuitry 311 for ascertaining the health of a PV panel. For one embodiment, the Op-Amp based signal conditioning circuit 307 interfaces with the data-acquisition circuit 311 to process the acquired PV panel data into one or more signals that are provided to the PWM generation circuit 309.

As used herein, a “PWM generation circuit” or its variations refer to one or more circuits that generate one or more PWM signals for setting a switching frequency used to perform a sweep of a duty cycle of the high-voltage (HV) and/or low-voltage (LV) components of an inverter molecule. For example, and for one embodiment, the PWM generation circuit 309 provides a first set of PWM signals to a component of the MFEC 322 and/or a second set of PWM signals to the DC-to-AC inverter 312 (e.g., a single stage inverter). For this embodiment, a sweep of the duty cycle to vary the output current allows for capturing the IV characteristic of the PV panel 302. The IV characteristic is generally represented as an I-V curve, as is known in the art.

For one embodiment, the I-V curve obtained from the IV sweep is reported back to the data-acquisition circuit 311 and used to determine at least one of a current generated by the PV panel 302, a voltage generated by the PV panel 302, or an actual yield of the PV panel 302. The determined information is provided to a cloud-based system (e.g., cloud-based system 108 of FIG. 1) for further processing.

FIG. 4 is a schematic illustration of an PV panel assembly 400 in accordance with an embodiment. The PV panel assembly 400 of FIG. 4 can be any of the PV panel assemblies described above in connection with at least one of FIGS. 1-3B. For one embodiment, the PV panel assembly 400 includes an MFEC 410, a LPF 430, a DC-to-AC inverter 440 (e.g., a single stage inverter), a PV panel (or other voltage source) 450, and a high frequency switching ripple capacitor 460. The DC-to-AC inverter 440 can be a multiple-stage inverter in other embodiments. The LPF 430 can also include a current shaping inductor (CSI) 432 and a filter capacitor 434. Other components can be provided with the PV panel assembly 400, but are not illustrated for simplicity purposes.

As explained above in connection with FIGS. 3A-3B, a PV panel assembly can include high-voltage (HV) components and/or low-voltage (LV) components. In FIG. 4, the HV components are shown with bolder lines than the LV components. For one embodiment, one or more components of the PV panel assembly 400 includes both high-voltage (HV) and low-voltage (LV) components. For example, and for one embodiment, the MFEC 410 includes both HV and LV components, as illustrated in FIG. 4.

The HV component can comprise a metal-oxide-semiconductor field effect transistor (MOSFET) and/or insulated gate bipolar transistor (IGBT) with an anti-parallel ultrafast diode, while the LV component can comprise a MOSFET and/or Schottky diode combination. Depending on implementations, there can be advantages for using MOSFETS. MOSFET-based implementation of the PV panel assembly 400 can also benefit from the utilization of two different types of MOSFETs, as described above in connection with FIG. 3B.

For one embodiment, the PV panel assembly 400 also includes data-acquisition circuitry 476, Op-Amp based signal conditioning circuitry 476, and PWM generation circuitry 475. The data-acquisition circuitry 476 can obtain PV panel data from PV panel 450. For one embodiment, the acquired PV panel data includes at least one of a voltage across the PV panel 450 (V_{PV}), a current flowing through the PV panel 450 (I_{PV}), a current (I_{SWITCH}) of the LV component of the MFEC 440, a voltage across the output of LPF 430 (not shown in FIG. 4), a current output by the LPF 430 (not shown in FIG. 4), or a current of the inductor 432 (not shown in FIG. 4). For one embodiment, the acquired PV panel only includes the voltage across the PV panel 450 (V_{PV}) and the current flowing through the PV panel 450 (I_{PV}). For embodiments where the data-acquisition circuitry obtains the I_{SWITCH}, the I_{SWITCH} is used as a redundant value for the I_{PV}, which can be used to determine if there is an error in the measurement of the I_{PV} of the PV panel 450.

Based on the acquired PV panel data (which includes at least one of the I_{PV}, the V_{PV}, or the I_{SWITCH}), the Op-Amp based signal conditioning circuitry 476 processes the acquired PV panel data, generates multiple signals based on the processing, and provides the multiple signals to the PWM generation circuitry 475. For one embodiment, the multiple signals that are fed to the PWM generation circuitry 475 enable the PWM generation circuitry 475 to generate PWM signals that are used for controlling the HV and LV components of the PV panel assembly 400.

For one embodiment, the PWM generation circuitry 475 provides a first PWM signal 478 to the LV component of the MFEC 410, a second PWM signal 477 to the HV component of MFEC 410, and a third set of PWM signals 479 to the LV components of the inverter 440. For one embodiment, the first PWM signal 478 is used to control at least one of I_{PV}, V_{PV}, or I_{SWITCH}. For example, and for one embodiment, the first PWM signal 478 causes the switch of the LV component of the MFEC 410 to vary between “ON” and “OFF” states at a periodic rate. For this example, the varying of the switch of the LV component of the MFEC 410 between “ON” and “OFF” states at a periodic rate enables a control of at least one of I_{PV}, V_{PV}, or I_{SWITCH}. As illustrated in the FIG. 4, the first PWM signal 478 shows these variation. In that graph, T is the period, D is a value between 0 and 1, DT represents the time in each period that the switch is in an “ON” state. DT is a product of D and T. It is to be appreciated that, for some embodiments, the second PWM signal 477 and the third set of PWM signals 479 can be similar to or the same as the first PWM signal 478 described above. For another embodiment, and as illustrated in FIG. 4, the second PWM signal 477 and the third PWM signal 479 cause the respective switches to remain in an “OFF” state. By using each of the signals 477-479, an IV sweep may be performed on the PV panel assembly 450 to obtain an I-V curve as is known in the art

For one embodiment, the IV sweep is performed over a predetermined duration of time (e.g., an hourly basis, a daily basis, a weekly basis, a bi-weekly basis, etc.). For a further embodiment, the IV sweep is performed at varying solar insolation levels and/or environmental conditions (e.g., wind speeds, sunlight, temperature, other weather effects, etc.) that occur throughout a predetermined duration of time (e.g. a day, a week, etc.). As a first example, an IV sweep is performed at a solar insolation level that occurs in the morning when environmental conditions related to humidity levels can be accounted for. As a second example, an IV sweep is performed at a solar insolation level that occurs in middle of the day when environmental conditions related to the amount of sunlight can be accounted for (e.g., when the sun is brightest and high in the sky). Further, the data gathered from the IV sweep (e.g., the I-V curve) is correlated with the actual performance of the PV panel 450 to determine at least one of the following: (i) one or more key performance indicators (KPIs) of the PV panel 450; or (ii) a degradation profile of the PV panel 450.

As used herein, a “key performance indicator (KPI)” and its variations refer to an ideal performance characteristic or parameter of a PV panel (e.g., the PV panel 450). For example, and for one embodiment, a KPI can be a future yield of the PV panel 450 that is determined using the data gathered from the IV sweep. Example of a KPI includes, but is not limited to, a future current generated by a PV panel assembly, a future voltage generated by a PV panel assembly, a future yield of a PV panel, a future short circuit current of a PV panel, a future open circuit voltage of a PV panel, a predicted maximum power of a PV panel, a predicted voltage at a predicted maximum power of a PV panel, and a predicted current at a predicted maximum power of a PV panel. For one embodiment, a KPI is determined using one or more algorithms. Such algorithms for generating KPIs include, but are not limited to, algorithms based on regression analysis and algorithms based on Bayesian techniques.

As used herein, a “degradation profile” and its variations refer to a degradation rate of a PV panel (e.g., the PV panel 450). Thus, a degradation profile indicates a quantification of a change in abilities of a PV panel (e.g., the PV panel 450) to generate DC power over time for a given set of environmental conditions. For example, the change could be a decline in the abilities of the PV panel 450. For one embodiment, at least one of the KPIs or the degradation profile is used for fault diagnosis, fault detection, and/or yield prediction of a PV panel (e.g., the PV panel 450).

Each of the KPIs and the degradation profile can be computed over a durational window (e.g., a minutes-ahead window, an hours-ahead window, a days-ahead window, any other predetermined durational windows, etc.). Moreover, each of the KPIs or the degradation profile can be generated based on weather data acquired from a weather prediction system (e.g., the weather prediction system 109 described above in connection with FIG. 1). For one embodiment, the weather data enables the KPIs and/or the degradation profile to be more accurate given that it accounts for future solar insolation levels and/or environmental conditions (e.g., wind speeds, sunlight, temperature, other weather effects, etc.). As an example, a future yield of the PV panel 450 can be generated over a five-day window from a specified date. In this example, the estimate would also be based weather data acquired from a weather prediction system.

For one embodiment, the I-V curve includes performance characteristics of the PV panel 450. These performance characteristics include, but are not limited to, an actual yield of the PV panel 450 (i.e., a measure of energy derived from the power generated by the PV panel 450), a temperature characteristic of the PV panel 450, a voltage characteristic of the PV panel 450, or a current characteristic of the PV panel 450. These characteristics can be used to derive actual operating parameters of the PV panel 450. For one embodiment, the actual operating parameters include at least one of a series resistance value affecting the PV panel assembly 400, a shunt resistance value affecting the PV panel assembly 400, a diode ideality factor for each diode utilized to model the PV panel assembly 400, a dark saturation current (for each diode in the model) of the PV panel assembly 400, or a short circuit current of the PV panel assembly 400. A cloud-based system (e.g., system 108 of FIG. 1) can be used to determine model or ideal parameters from the actual parameters of the PV panel model 450. For one embodiment, corresponding model and derived parameters of the PV panel 450 are compared or correlated with each other for fault diagnosis, fault detection, and/or yield prediction of the PV panel 450.

KPIs, degradation rates, and parameters of the PV panel 450 vary as solar insolation levels and/or environmental conditions (e.g., wind speeds, sunlight, temperature, other weather effects, etc.) affecting the PV panel 450 vary. Thus, correlating the values of the KPI(s), degradation rates, and parameters at a specific set of solar insolation levels and/or environmental conditions with an actual performance value of the PV panel 450 at the same specific solar insolation levels and/or environmental conditions can show whether the PV panel is operating abnormally.

For one embodiment, at least one of the characteristics associated with the PV panel 450, the parameters associated with the PV panel 450, or the KPIs associated with the PV panel 450 is used by a cloud-based system (e.g., system 108 of FIG. 1) to generate an adaptive panel model of the PV panel 450. For one embodiment, the adaptive panel model of the PV panel 450 is normalized to account for the variations in solar insolation levels. In this way, the adaptive model can be used for fault diagnosis, fault detection, and/or yield prediction of the PV panel 450. This is because the characteristics associated with the PV panel 450, the parameters associated with the PV panel 450, or the KPIs associated with the PV panel 450 within the normalized model should not vary unless the PV panel 450 is operating abnormally. Additional details about an adaptive panel model are described above in connection with FIG. 1.

As a first example, a normalized adaptive panel model of PV panel 450 can diagnose an abnormal operation of the PV panel 450 based on an actual shunt resistance affecting the PV panel assembly 400. In this first example, a large and abnormal variation in the actual shunt resistance (when compared to the idealized shunt resistance) may signify a leakage path for the I_{PV}. This leakage path can be symptomatic of a leakage path from the PV panel assembly 400 to a frame housing the PV panel assembly 400. Normally, the PV panel assembly 400 is housed in a frame (e.g., a frame 201 of FIG. 2) to protect the PV panel assembly 400 from natural elements, unnecessary wear-and-tear, and other environmental accidents. However, the leakage current through the frame can create a ground fault current, which may lead to a hazard condition and eventual failure of the PV panel assembly 400. In a PV power plant comprised of multiple PV panel assemblies 400, such a fault current can lead to a catastrophic failure of the PV plant.

As a second example, a normalized adaptive panel model generated for two or more PV panels 450 can diagnose an abnormal operation of the multiple PV panels 450 based on an actual series resistance between the multiple PV panels 450. In this second example, a large and abnormal variation in the actual series resistance (as opposed to the idealized series resistance) may signify an abnormal degradation of at least one of the PV panels 450, which could lead to energy waste and further degradation of the panels 450. If one of the multiple panels 450 is degrading faster than the others, this could potentially degrade the other panels 450 in a PV panel assembly or a PV plant.

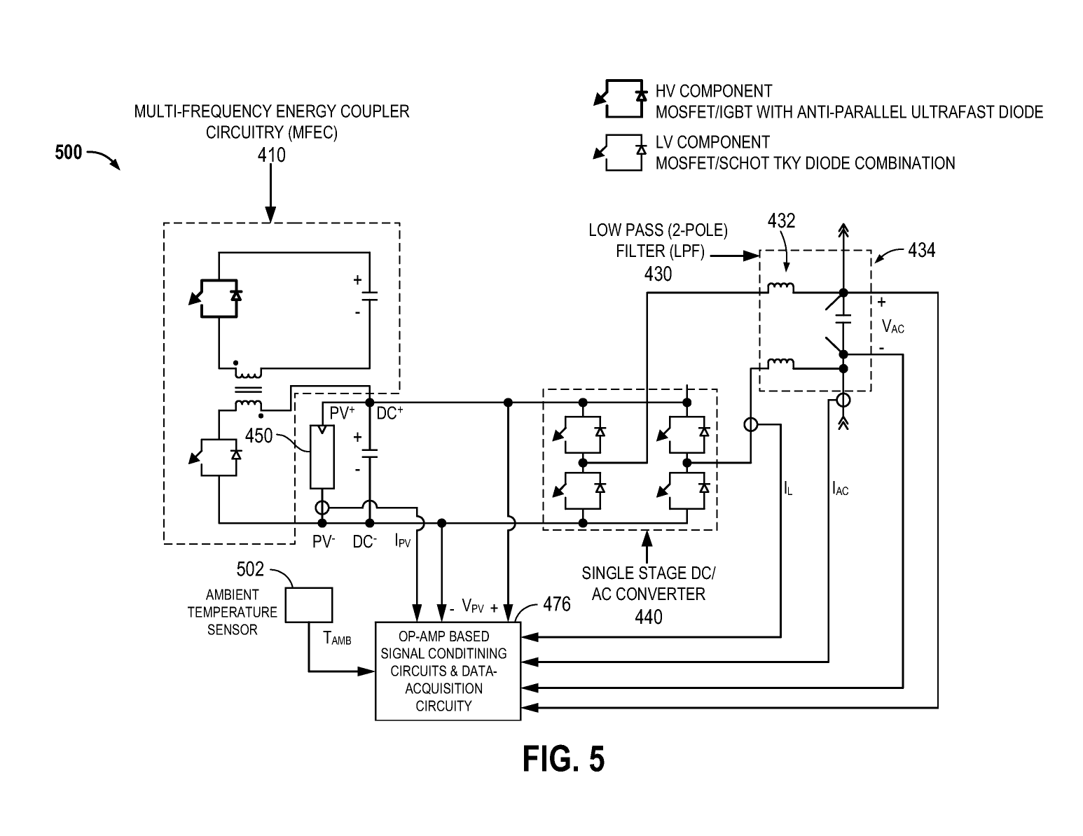

FIG. 5 is a schematic illustration of PV panel assembly 500 in accordance with an embodiment. PV panel assembly 500 is similar to or the same as the PV panel assembly 400 described above in connection with FIG. 4. For one embodiment, PV panel assembly 500 is a further embodiment of the PV panel assembly 400. Thus, for this embodiment, all of the components of PV panel assembly 400 can be part of the PV panel assembly 500. For the sake of brevity, only the differences between the PV panel assembly 500 and the PV panel assembly 400 will be described below in connection with FIG. 5.

One difference between the PV panel assembly 500 and the PV panel assembly 400 is the presence of the ambient temperature sensor 502. In the illustrated embodiment of the PV panel assembly 500, the sensor 502 is included to obtain varying solar insolation and operating temperatures for the PV panel assembly 500. In this way, PV panel data obtained from the components of the PV panel assembly 500 can be correlated with the different solar insolation and operating temperatures, normalized to account for the different solar insolation and operating temperatures, and used to generate an adaptive panel model. For example, and for one embodiment illustrated in FIG. 5, the data-acquisition circuitry obtains PV panel data. In this example, the acquired PV panel data includes at least one of a voltage across the PV panel 450 (V_{PV}), a current flowing the PV panel 450 (I_{PV}), a voltage across the output of LPF 430 (V_{AC}), a current output by the LPF 430 (I_{AC}), or a current of the inductor 432 (I_{L}). Further, in this example, the PV panel data is acquired at various solar insolation and operating temperatures (T_{AMB}) that are measured by the ambient temperature sensor 502. The acquired panel data obtained from the components of the PV panel assembly 500 are then correlated with the corresponding T_{AMB}, normalized to account for the differences, and used to generate an adaptive panel model.

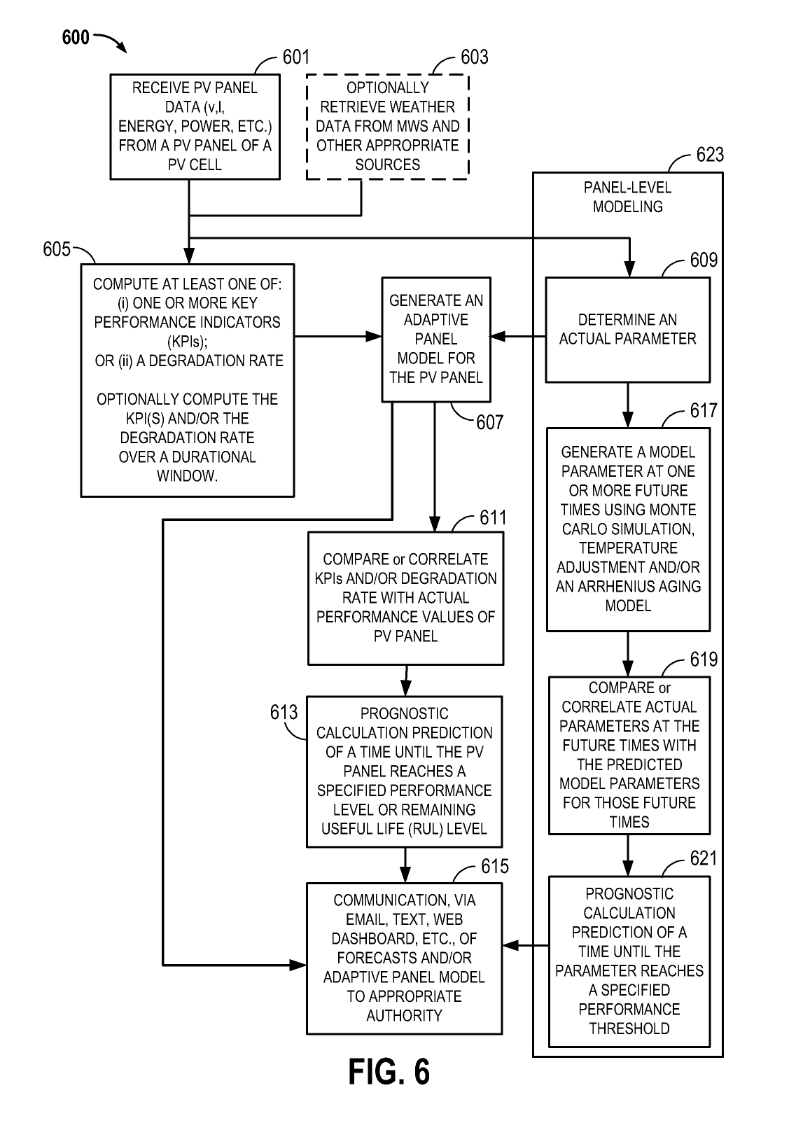

FIG. 6 is a flow chart illustration of process 600 of fault detection, fault diagnosis, and/or yield prediction in accordance with one embodiment. Each of the blocks of process 600 can be performed by one or more of the components of the systems, devices, and/or computers described above in connection with at least one of FIGS. 1-5. For example, the system 100 of FIG. 1 can perform process 600.

Process 600 begins at blocks 601 and 603. At block 601, a cloud-based system (e.g., the cloud-based system 108 described above in connection with FIG. 1) receives acquired PV panel data for a PV panel of PV panel assembly. Moreover, weather information can also optionally be retrieved by the cloud-based system from a weather prediction system (e.g., the weather prediction system 109 described above in connection with FIG. 1). Acquisition of PV panel data is described above in connection with at least FIGS. 3A-5. Retrieval of weather data is described above in connection with at least FIG. 1.

At block 605, the cloud-based system computes at least one of a KPI of the PV panel or a degradation rate of the PV panel. For a further embodiment, the cloud-based system computes at least one KPI for the PV panel (e.g., a future yield, a future current, or a future voltage of the PV panel model). For yet another embodiment, at least one of a KPI of the PV panel or a degradation rate of the PV panel is computed over a durational window. KPIs, degradation rates, and durational windows are described above in connection with at least FIGS. 1 and 4-5. Furthermore, the cloud-based system determines actual parameters for the PV panel at block 609. Actual parameters are described above in connection with at least FIGS. 4-5. In block 607, the cloud-based system uses the outputs of blocks 605 and 609 to generate an adaptive panel model for the PV panel. The generation of this model is described above in connection with at least FIGS. 1 and 3A-5. At block 615, the generated adaptive panel model can be reported to a remote monitoring system associated with a third party (e.g., remote monitoring system 106 described above in connection with FIG. 1).

At block 611, the cloud-based system compares or correlates at least one of the KPIs or the degradation rate with the actual performance of the PV model. At block 613, the cloud-based system uses the results of the comparison or correlation performed in block 611 to predict a future time when the PV panel will reached a specified remaining useful life (RUL) level. These prediction mechanisms are known in the art, and as a result, they will not be described in detail.

With regard to the parameters of the PV panel, the cloud-based system generates model parameters at future times using at least one of a Monte Carlo simulation, a temperature adjustment model, an Arrhenius aging model, or other methodologies used for future prediction as known in the art at block 617. For example, and for one embodiment, an aging model that is normalized for weather conditions is used for estimating the shunt resistance associated with a PV panel. Specifically, this normalized shunt resistance will be aged using the following equation Rₛₕ=R_{sh,0}×e^{(a×t)} where Rₛₕ represents the shunt resistance, t represents time since the panel was first deployed, R_{sh,0} represents the initial value of Rₛₕ when first measured at t=0 (i.e. the first measurement ever made after deploying the panel), and a represents a constant value (in ideal situations) or a slowly varying constant (that changes over time).

Further, at block 619, the cloud-based system compares the actual parameters at those future times with the predicted model parameters of block 617. At block 621, the cloud-based system uses the results of block 619 to predict a time when the actual parameter will reach a specified performance threshold.

At block 615, the cloud-based system reports the forecasts determined in blocks 613 and 621 to a remote monitoring computer or system associated with a third party (e.g., an electrical utilities company, an ISO, a plant dispatcher, etc.) that uses the forecasts for controlling power generation and distribution.

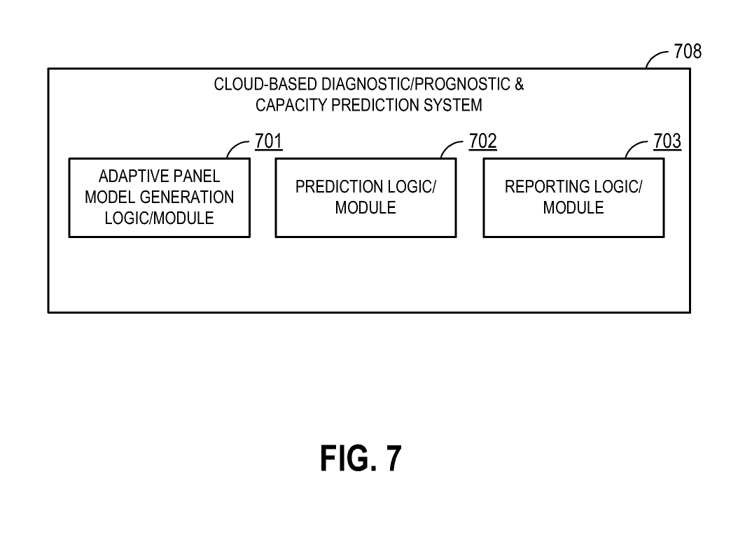

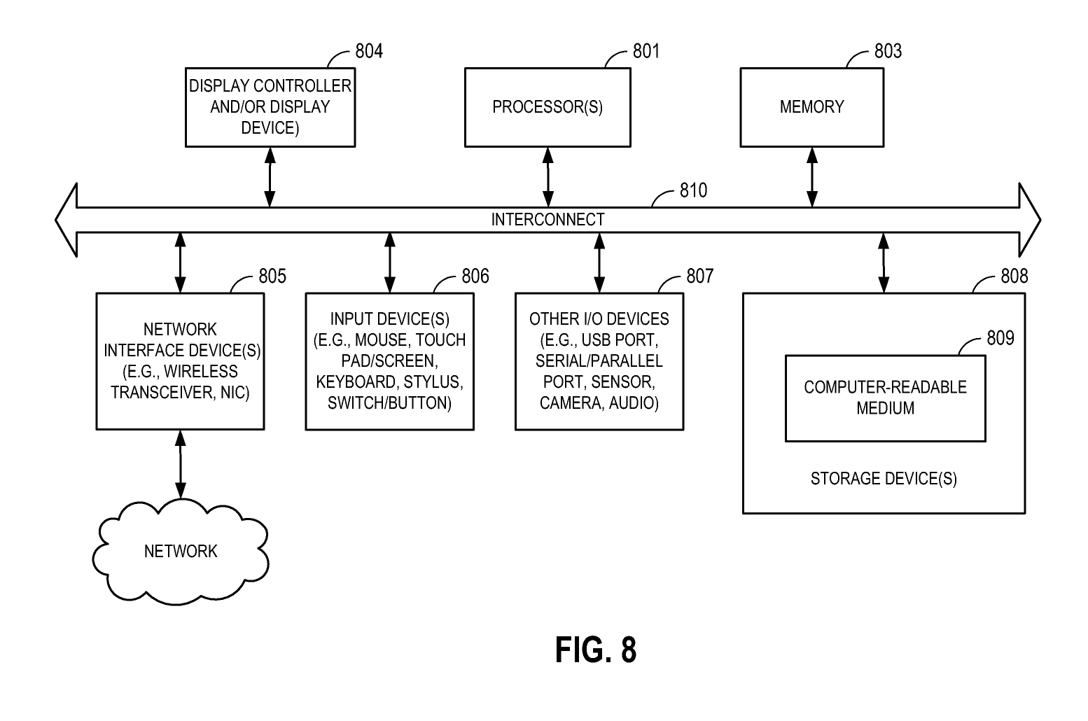

FIG. 7 is a block diagram illustration of the cloud-based system 708 in accordance with one embodiment. For one embodiment, the system 708 is similar to or the same as the system 108 described above in connection with FIG. 1. The system 708 can be include at least one data processing system, such as the data processing 800 described below in connection with FIG. 8. For one embodiment, the system 708 includes an adaptive panel model generation logic/module 701. The logic/module 701 performs the generation of the adaptive panel as described above in at least one FIGS. 1-6. For example, the adaptive panel generation logic/module performs each of the operations of blocks 601, 603, 605, and 609 of process 600, which is described above in connection with FIG. 6. For one embodiment, the system 108 includes a prediction logic/module 702 that performs the prediction of power capacity or degradation of a PV panel as described above in at least one of FIGS. 1-6. For example, the prediction logic/module 702 performs each of the operations of blocks 611, 613, 617, 619, and 621 of process 600, which is described above in connection with FIG. 6. For an embodiment, the system 108 includes a reporting logic/module 703 that reports the outputs of the logic/module 701 and the logic/module 702 to a remote monitoring system associated with a third party (e.g., remote monitoring system 106 described above in connection with FIG. 1). For example, the reporting logic/module 703 performs each of the reporting operations of block 615, which is described above in connection with FIG. 6.

FIG. 8 is a block diagram illustrating an example of a data processing system 800 that may be used with at least one of the embodiments described herein. For example, system 800 may represent a data processing system for performing any of the processes or methods described above in connection with any of FIGS. 1-7. System 800 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 800 is intended to show a high-level view of many components of the computer system. However, it is to be understood that additional components may be present in certain implementations and furthermore, different arrangement of the components shown may occur in other implementations. System 800 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 800 includes processor 801, memory 803, and devices 805-808 via a bus or an interconnect 810. Processor 801 may represent a single processor or multiple processors with a single processor core or multiple processor cores included therein. Processor 801 may represent one or more general-purpose processors such as a microprocessor, a central processing unit (CPU), or the like. More particularly, processor 801 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 801 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 801, which may be a low power multi-core processor socket such as an ultra-low voltage processor, may act as a main processing unit and central hub for communication with the various components of the system. Such processor can be implemented as a system on chip (SoC). Processor 801 is configured to execute instructions for performing the operations and/or steps discussed herein. System 800 may further include a graphics interface that communicates with optional graphics subsystem 804, which may include a display controller, a graphics processor, and/or a display device.

Processor 801 may communicate with memory 803, which in one embodiment can be implemented via multiple memory devices to provide for a given amount of system memory. Memory 803 may include one or more volatile storage (or memory) devices such as random access memory (RAM), dynamic RAM (DRAM), synchronous DRAM (SDRAM), static RAM (SRAM), or other types of storage devices. Memory 803 may store information including sequences of instructions that are executed by processor 801 or any other device. For example, executable code and/or data of a variety of operating systems, device drivers, firmware (e.g., input output basic system or BIOS), and/or applications can be loaded in memory 803 and executed by processor 801. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 800 may further include I/O devices such as devices 805-808, including network interface device(s) 805, optional input device(s) 806, and other optional IO device(s) 807. Network interface device 805 may include a wireless transceiver and/or a network interface card (NIC). The wireless transceiver may be a WiFi transceiver, an infrared transceiver, a Bluetooth transceiver, a WiMax transceiver, a wireless panel assemblyular telephony transceiver, a satellite transceiver (e.g., a global positioning system (GPS) transceiver), or other radio frequency (RF) transceivers, or a combination thereof. The NIC may be an Ethernet card.

Input device(s) 806 may include a mouse, a touch pad, a touch sensitive screen (which may be integrated with display device 804), a pointer device such as a stylus, and/or a keyboard (e.g., physical keyboard or a virtual keyboard displayed as part of a touch sensitive screen). For example, input device 806 may include a touch screen controller coupled to a touch screen. The touch screen and touch screen controller can, for example, detect contact and movement or a break thereof using any of multiple touch sensitivity technologies, including but not limited to capacitive, resistive, infrared, and surface acoustic wave technologies, as well as other proximity sensor arrays or other elements for determining one or more points of contact with the touch screen.

I/O devices 807 may include an audio device. An audio device may include a speaker and/or a microphone to facilitate voice-enabled functions, such as voice recognition, voice replication, digital recording, and/or telephony functions. Other IO devices 807 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 807 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 1510 via a sensor hub (not shown), while other devices such as a keyboard or thermal sensor may be controlled by an embedded controller (not shown), dependent upon the specific configuration or design of system 800.

To provide for persistent storage of information such as data, applications, one or more operating systems and so forth, a mass storage (not shown) may also couple to processor 801. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. In addition, a flash device may be coupled to processor 801, e.g., via a serial peripheral interface (SPI). This flash device may provide for non-volatile storage of system software, including a basic input/output software (BIOS) as well as other firmware of the system.

Storage device 808 may include computer-accessible storage medium 809 (also known as a machine-readable storage medium or a computer-readable medium) on which is stored one or more sets of instructions or software embodying any one or more of the methodologies or functions described herein. Embodiments described herein (e.g., the process 600 described above in connection with FIG. 6) may also reside, completely or at least partially, within memory 803, and/or within processor 801 during execution thereof by data processing system 800, memory 803, and processor 801 also constituting machine-accessible storage media. Modules, units, or logic configured to implement the embodiments described herein (e.g., the process 600 described above in connection with FIG. 6) may further be transmitted or received over a network via network interface device 805.

Computer-readable storage medium 809 may also be used to store some software functionalities described above persistently. While computer-readable storage medium 809 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the embodiments described herein. The term “computer-readable storage medium” shall accordingly be taken to include, but not be limited to, solid-state memories, and optical and magnetic media, or any other non-transitory machine-readable medium.

Components and other features described herein can be implemented as discrete hardware components or integrated in the functionality of hardware components such as ASICS, FPGAs, DSPs, or similar devices. In addition, any of the components described above in connection with any one of FIGS. 1-7 can be implemented as firmware or functional circuitry within hardware devices. Further, these components can be implemented in any combination hardware devices and software components.

Note that while system 800 is illustrated with various components of a data processing system, it is not intended to represent any particular architecture or manner of interconnecting the components; as such, details are not germane to embodiments described herein. It will also be appreciated that network computers, handheld computers, mobile phones, servers, and/or other data processing systems, which have fewer components or perhaps more components, may also be used with embodiments described herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as is apparent from the above discussion, it is appreciated that throughout the description, some of the discussions utilizing terms such as those set forth in the claims below, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments described herein are not described with reference to any particular programming language. It will be appreciated that a variety of programming languages may be used to implement the teachings of the embodiments described herein.

In the foregoing specification, embodiments set forth herein have been described with reference to specific exemplary embodiments thereof. It will be evident that various modifications may be made thereto without departing from the broader spirit and scope of one or more of the inventive concepts as set forth in the following claims. The specification and drawings are, accordingly, to be regarded in an illustrative sense rather than a restrictive sense.

References in the specification to “one embodiment,” “an embodiment,” “an exemplary embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Furthermore, when a particular feature, structure, or characteristic is described in connection with an embodiment, such feature, structure, or characteristic may be implemented in connection with other embodiments whether or not explicitly described. Additionally, as used herein, the term “exemplary” refers to embodiments that serve as simply an example or illustration. The use of exemplary should not be construed as an indication of preferred examples. Numerous specific details are described to provide a thorough understanding of various embodiments described herein. However, in certain instances, well-known or conventional details are not described in order to provide a concise discussion of embodiments described herein.

In the description and claims set forth herein, the terms “coupled” and “connected,” along with their derivatives, may be used. It should be understood that these terms are not intended as synonyms for each other. “Coupled” and its variations are used to indicate that two or more elements, which may or may not be in direct physical or electrical contact with each other, co-operate or interact with each other. “Connected” and its variations are used to indicate the establishment of communication between two or more elements that are coupled with each other. For example, two devices that are connected to each other are communicatively coupled to each other. “Communication” and its variations includes at least one of transmitting or forwarding of information to an element or receiving of information by an element. The terms “system,” “device,” “computer,” “terminal,” and their respective variations are intended to refer generally to data processing systems (e.g., the data processing system 800 described above in connection with FIG. 8) rather than specifically to a particular form factor for the system and/or device. It will be evident that various modifications may be made to the embodiments described herein without departing from the broader spirit and scope of the claimed embodiments.

What is claimed is:

1. A photovoltaic (PV) panel assembly comprising:
a first PV panel configured to generate direct current (DC) power; and
an inverter molecule coupled to the first PV panel, the inverter molecule being configured to convert the DC power generated by the first PV panel into alternating current (AC) power and the inverter molecule including a monitoring device, the monitoring device being configured to monitor a condition of the first PV panel, wherein:
the monitored condition of the first PV panel is converted into electronic data that is used to create a first adaptive PV panel model for the first PV panel.

2. The PV panel assembly of claim 1, wherein the monitored condition of the first PV panel includes at least one of:
an actual yield of the first PV panel, the actual yield of the first PV panel being a measure of energy derived from power generated by the first PV panel;
a temperature characteristic of the first PV panel;
a voltage characteristic of the first PV panel; or
a current characteristic of the first PV panel.

3. The PV panel assembly of claim 2, wherein the monitoring of the condition is performed in real-time or on demand.

4. The PV panel assembly of claim 1, wherein at least one of a key performance indicator (KPI) of the first PV panel or a degradation profile of the first PV panel is generated over a durational window based on the first adaptive PV panel model, the KPI of the first PV panel being indicative of at least one of a future yield of the first PV panel, a future short circuit current of the first PV panel, a future open circuit voltage of the first PV panel, a predicted maximum power of the first PV panel, a predicted voltage at a predicted maximum power of the first PV panel, and a predicted current at a predicted maximum power of the first PV panel, and the degradation profile of the first PV panel being indicative of a quantification of a decline in an ability of the first PV panel to generate DC power over time.

5. The PV panel assembly of claim 4, wherein the durational window includes at least one of:
a seconds-ahead window;
a minutes-ahead window;
a hours-ahead window; or
a days-ahead window.

6. The PV panel assembly of claim 4, wherein the generation of at least one of the KPI of the first PV panel or the degradation profile of the first PV panel is based on weather data.

7. The PV panel assembly of claim 1, further comprising a second PV panel configured to generate direct current (DC) power, wherein:
the inverter molecule is coupled to the second PV panel;
the inverter molecule is configured to convert the DC power generated by the second PV panel into alternating current (AC) power;
the monitoring device is configured to monitor a condition of the second PV panel; and
the monitored condition of the second PV panel is converted into electronic data that is used to create a second adaptive PV panel model for the second PV panel.

8. The PV panel assembly of claim 7, wherein the monitored condition of the second PV panel includes at least one of:
an actual yield of the second PV panel, the actual yield of the second PV panel being a measure of energy derived from the power generated by the second PV panel;
a temperature characteristic of the second PV panel;
a voltage characteristic of the second PV panel; or
a current characteristic of the second PV panel.

9. The PV panel assembly of claim 8, wherein the first and second adaptive PV panel models are aggregated to form a third adaptive PV panel model, wherein at least one of a KPI of the first and second PV panels or a degradation profile of the first and second PV panels is generated over a durational window based on the third adaptive PV panel model, the KPI of the first and second PV panels being indicative of at least one of a future yield of the first and second PV panels, a future short circuit current of the first and second PV panels, a future open circuit voltage of the first and second PV panels, a predicted maximum power of the first and second PV panels, a predicted voltage at a predicted maximum power of the first and second PV panels, and a predicted current at a predicted maximum power of the first and second PV panels, and the degradation profile of the first and second PV panels being indicative of a quantification of a decline in abilities of the first and second PV panels to generate DC power over time.

10. The PV panel assembly of claim 9, wherein at least one of the KPI of the first and second PV panels or the degradation profile of the first and second PV panels is transmitted to a third party and wherein the third party includes at least one of an electrical utilities company or an independent system operator (ISO).

11. The PV panel assembly of claim 1, wherein at least one of the future yield of the first PV panel or the degradation profile of the first PV panel is transmitted to a data processing system associated with a third party and wherein the third party includes at least one of an electrical utilities company or an independent system operator (ISO).

12. The PV panel assembly of claim 1, wherein at least one of the KPI of the first PV panel or the degradation profile of the first PV panel is used to detect or diagnose the first PV panel when the first PV panel exhibits an abnormal characteristic.

13. A solar PV capacity predicting or forecasting system comprising one or more processing devices, the one or more processing devices being configured to:
monitor a condition of a first photovoltaic (PV) panel using a monitoring device,
wherein a PV panel assembly includes the first PV panel and an inverter molecule that is coupled to the first PV panel, wherein the first PV panel is configured to generate direct current (DC) power, wherein the inverter molecule is configured to convert the DC power generated by the first PV panel into alternating current (AC) power and wherein the inverter molecule includes the monitoring device;
process electronic data representing the monitored condition by the one or more processing devices;
create a first adaptive PV panel model based on the processed data; and
generate at least one of a KPI of the first PV panel or a degradation profile of the first PV panel over a durational window based on the first adaptive PV panel model.

14. The system of claim 13, wherein the durational window includes at least one of: a minutes-ahead window, a hours-ahead window, or a days-ahead window.

15. The system of claim 13, wherein the monitored condition includes at least one of:
an actual yield of the first PV panel, the actual yield of the first PV panel being a measure of energy derived from the power generated by the first PV panel;
a temperature characteristic of the first PV panel;
a voltage characteristic of the first PV panel; or
a current characteristic of the first PV panel.

16. The system of claim 13, wherein the KPI of the first PV panel is indicative of at least one of a future yield of the first PV panel, a future short circuit current of the first PV panel, a future open circuit voltage of the first PV panel, a predicted maximum power of the first PV panel, a predicted voltage at a predicted maximum power of the first PV panel, and a predicted current at a predicted maximum power of the first PV panel, and wherein the degradation profile of the first PV panel is indicative of a quantification of a decline in an ability of the first PV panel to generate DC power over time.

17. The system of claim 13, wherein the generation of at least one of the future yield of the first PV panel or the degradation profile of the first PV panel is based on weather data.

18. The system of claim 13, further comprising a second PV panel configured to generate direct current (DC) power, wherein:
the inverter molecule is coupled to the second PV panel;
the inverter molecule is configured to convert the DC power generated by the second PV panel into alternating current (AC) power;
the monitoring device is configured to monitor a condition of the second PV panel; and
the monitored condition of the second PV panel is converted into electronic data that is used to create a second adaptive PV panel model for the second PV panel.

19. The system of claim 18, wherein the monitored condition of the second PV panel includes at least one of:
an actual yield of the second PV panel, the actual yield of the second PV panel being a measure of energy derived from the power generated by the second PV panel;
a temperature characteristic of the second PV panel;
a voltage characteristic of the second PV panel; or
a current characteristic of the second PV panel.

20. The system of claim 18, wherein the first and second adaptive PV panel models are aggregated to form a third adaptive PV panel model, wherein at least one of a KPI of the first and second PV panels or a degradation profile of the first and second PV panels is generated over a durational window based on the third adaptive PV panel model, the KPI of the first and second PV panels being indicative of at least one of a future yield of the first and second PV panels, a future short circuit current of the first and second PV panels, a future open circuit voltage of the first and second PV panels, a predicted maximum power of the first and second PV panels, a predicted voltage at a predicted maximum power of the first and second PV panels, or a predicted current at a predicted maximum power of the first and second PV panels, and the degradation profile of the first and second PV panels being indicative of a quantification of a decline in an ability of the first and second PV panels to generate DC power over time.
